(19) United States
(12) Patent Application Publication
(10) Pub. No.: US 2006/0290999 A1
(43) Pub. Date: Dec. 28, 2006

(54) Image processing apparatus and network system

(75) Inventors: Kenji Ebitani, Kanagawa (JP); Michihiro Tamune, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/332,244

(22) Filed: Jan. 17, 2006

(30) Foreign Application Priority Data
Jun. 22, 2005 (JP) 2005-181383

(51) Int. Cl. H04N 1/00

(52) U.S. Cl. 358/426.06; 358/1.15

(57) ABSTRACT

An image processing apparatus includes an image reading portion that reads an image of an original to obtain image data; an extraction portion that extracts original attribute information for representing format type of the original from the image data; an information storage portion that stores the original attribute information; a data reduction portion that reduce a data amount of the image data; and a data transfer portion that transfer the image data through a network. The image reading portion obtains the image data while determining if the original attribute information is stored in the information storage portion. When it is determined that the original attribute information is stored in the information storage portion, the data reduction portion reduces the image data to be transferred by the data transfer portion.

### BACKGROUND OF THE INVENTION

1. Field of the Invention

The present invention relates to an image processing apparatus having the function of reading an image of an original, and to a network system having the same.

2. Description of the Related Art

Generally, among learning materials intended for educational institutes such as educational establishments and private preparatory schools, which are published by educational material publishers or the like, question sheets of the same kind (for example, the same subject, the same school year, or the same unit of learning content) are supplied in units of tens of sheets. For instance, when a test is conducted on 30 students in one class, 30 question sheets on which each of the students marked answers are obtained. Alternatively, in a case where question sheets are separated from answer sheets, 30 answer sheets on which each of the students marked answer are obtained.

As described above, when a test is conducted on students of the same class by using question sheets of the same kind, the question sheets of the same kind and of the same number as that of the students are collected. The collected question sheets (or answer sheets) are graded one by one by a teacher in charge of the class. Before grading the question sheets, the teacher checks the answers which are entered in answer columns which are set on each of the question sheets one by one to decide whether each of the answers is correct. Then, the teacher marks each correct answer with a circle, and also marks each incorrect answer with an X-mark. That is, the teacher performs what is called “circling” (answer check). Further, when grading, the teacher gives test scores to the students according to an allocation of marks to the questions. It takes much effort to repeatedly perform this grading operation on many question sheets of the same kind. Thus, JP-A-8-30187 describes the invention relating to an automatic marking apparatus configured so that answer sheets for a test are read by a reading unit, and that the results of reading the answer sheets are inputted to a computer, and then, a marking operation is performed.

### SUMMARY OF THE INVENTION

However, a related art (the automatic marking apparatus) is configured so that a single apparatus performs a process from an operation of reading an answer sheets to a marking operation. Thus, the apparatus itself is considerably specialized and is large-sized. An effective countermeasure against to this is to employ an automatic marking system configured so that a unit (hereinafter referred to as a first unit) adapted to read answer sheets are separated from a unit (hereinafter referred to as a second unit) adapted to perform a marking operation.

Nowadays, network-compatible scanner units, digital copying machines, and digital multifunction machines are provided. The first unit can be constituted by using these apparatuses. The second unit can be constituted by a personal computer (hereinafter referred to as a PC) by installing an automatic marking program in the PC. In this instance, in the case of employing a system configuration in which the first unit and the second unit are connected by a network in order to realize the automatic marking processing of the question sheets on which answers have been entered. It is necessary to transfer image data of the question sheet read by the first unit to the second unit through the network. Further, it is necessary to specify which of the question sheet is represented by the image data transferred to the second unit from the first unit and is also necessary to retrieve information which is needed for giving marks to the question sheets from a database or the like.

Incidentally, a method of specifying the question sheets by preliminarily printing IDs for identifying the question sheets on the question sheets and by reading the IDs from image data is considered to be a method of specifying the question sheet to the second unit by using the image data transferred from the first unit. At that time, in a case where a barcode constituted by a monochrome image pattern or a two-dimensional code such as a “QR CODE” (registered trademark) is printed as the ID, a layout and a design of the question sheet are limited. Furthermore, the printing of the barcode or the two-dimensional code on the question sheet on which personal information representing a full name or the like is entered may cause students and guardians to have unnecessary distrust about information management and to make a bad impression.

In view of such circumstances, in a case where each of the question sheets is identified by the ID, preferably, the ID is embedded in the image of the question sheet as watermark code information (representing a watermark or the like) obtained by utilizing electronic watermark techniques. Practically, the watermark code information is preliminarily embedded in a preset part of an image representing the question sheet. Then, image data obtained by reading the image, in which this watermark code information is embedded, through the use of the first unit is transferred to the second unit. Subsequently, the second unit extracts and decodes the watermark code information from the transferred image data to thereby obtain the identifying ID.

Generally, in a case where a resolution (hereinafter referred to as a “first resolution”) needed in the automatic marking to determine whether the answer is correct (or whether the answer is right) is compared with a resolution (hereinafter referred to as a “second resolution”) needed to decode the watermark code information when the image of the question sheet is read, the first resolution is significantly lower than the second resolution. However, it is necessary to set the resolution that enables the question sheet to be read by the first unit so as to be equal to or higher than the second resolution in order to obtain the ID at the second unit. Thus, in the case of employing the aforementioned automatic marking system, a data amount (the number of bytes) of image data per question sheet is large. Accordingly, the transfer of the image data between the first unit and the second unit takes time.

Although the ID is obtained by decoding the watermark code information at the first unit, the data amount of image data to be transferred to the second unit can be decreased, there is necessity for building special processing functions, which are needed for internal software processing, in the first unit in the case of constituting the first unit by a digital copying machine or a digital multifunction machine, as described above. This results in reduction in productivity and also results in complication of processing. The related system has a drawback in that the system cannot flexibly be adapted to the addition of the processing function and to the change in specifications.

The present invention has been made in view of the above circumstances and provides an image processing apparatus and a network system. The embodiment of the present invention addresses an image processing apparatus to perform the efficient transfer of image data in a case where image data of originals of the same format including watermark code information is exchanged on a network many times.

According to an aspect of the present invention, there is provided an image processing apparatus including: an image reading portion that reads an image of an original to obtain image data; an extraction portion that extracts original attribute information for representing format type of the original from the image data; an information storage portion that stores the original attribute information; a data reduction portion that reduce a data amount of the image data; and a data transfer portion that transfer the image data through a network. The image reading portion obtains the image data while determining if the original attribute information is stored in the information storage portion. When it is determined that the original attribute information is stored in the information storage portion, the data reduction portion reduces the image data to be transferred by the data transfer portion.

### BRIEF DESCRIPTION OF THE DRAWINGS

Embodiments of the present invention will be described in detail based on the following figures, wherein:

FIG. 1 is a view illustrating the general configuration of a network system according to an embodiment of the invention;

FIG. 2 is a block view illustrating the functional portion of a digital multifunction machine according to an embodiment of the invention;

FIG. 3 is a view illustrating the form of a question sheet to be processed in the embodiment of the invention;

FIG. 4 is a view illustrating a state in which what is called the circling is performed on the question sheet shown in FIG. 3;

FIG. 5 is a flowchart illustrating a practical procedure for performing an image processing method according to an embodiment of the invention;

FIG. 6 is a view illustrating an example of a state in which question sheets are set;

FIG. 7 is a view illustrating another example of a state in which question sheets are set;

### DETAILED DESCRIPTION OF THE INVENTION

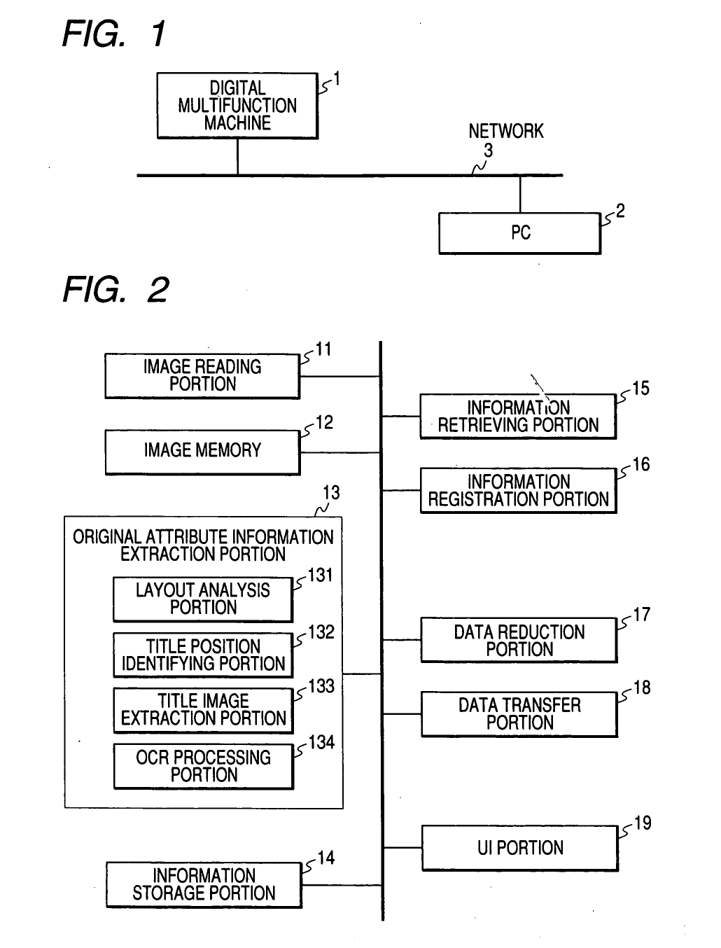

Hereinafter, a practical embodiment of the invention is described in detail by referring to the accompanying drawings. FIG. 1 is a view illustrating the general configuration of a network system according to an embodiment of the invention. The network system shown in this figure is configured so that a digital multifunction machine 1 and a PC 2 are connected to each other through a network 3. The digital multifunction machine 1 is adapted to transfer image data obtained by reading an image of an original. The PC 2 is adapted to perform a predetermined operation by using this image data.

For example, in a case where a question sheet (a learning material in the form of a test) on which entering answers and also a circling (answer check) are performed is treated as an original, an image of this question sheet is read by the digital multifunction machine 1. Image data obtained by this reading is transferred from the digital multifunction machine 1 to the PC 2 through the network 3. In the PC 2, a marking operation is performed by using the image data transferred there to through the network. Further, in a case where a questionnaire sheet, on which answers have been entered, is treated as an original, an image of this questionnaire sheet is read by the digital multifunction machine 1. Then, image data obtained by this reading is transferred from the digital multifunction machine 1 to the PC 2 through the network 3. Then, the PC 2 performs an operation of collecting resultant questionnaire sheets by using the image data transferred through the network.

The digital multifunction machine 1 has a scanning function of reading an image of an original, a printing function of printing out image data, and a copying function of copying out an image of an original, as basic functions. Further, the digital multifunction machine 1 has an automatic document feeder (ADF) adapted to automatically feed an original to an image reading position. Incidentally, although the digital multifunction machine 1 is exemplified herein, a scanner apparatus or a digital copying machine may be used instead of the digital multifunction machine.

The PC 2 has a PC main unit on which a CPU (Central Processing Unit), a memory, a hard disk, and the like are mounted, input devices, such as a keyboard and a mouse, and a display device, such as a liquid crystal display unit. Each of the digital multifunction machine 1 and the PC 2 has a communicating function used to perform bidirectional communication through the network 3. The network 3 is constituted by, for instance, a LAN (Local Area Network).

FIG. 2 is a block view illustrating a part of the function of the digital multifunction machine 1. An image reading portion 11 is adapted to optically read an image of an original and to generate image data according to a result of this reading. The image reading portion 1 includes an image forming optical system (a lamp, a mirror, a lens, and the like) adapted to irradiate a read surface of an original with light at an image reading position on a platen glass plate and to form an image at a predetermined position from light reflected from the read surface, a CCD (Charge Coupled Device) line sensor adapted to receiving reflection light at the predetermined position and to perform photoelectric conversion, and a processing board adapted to perform predetermined preprocessing (gain adjustment, offset adjustment, AD-conversion, shading correction, and the like) on image data generated by the photoelectric conversion at this CCD line sensor.

The image memory 12 is adapted to store image data of an original read by the image reading portion 11. The image memory 12 may be constituted by, for instance, a volatile memory, such as a DRAM (Dynamic Random Access Memory).

An original attribute information extraction portion 13 is adapted to extract original attribute information from image data of an original read by the image reading portion 11. The original attribute information representing the format type of an original. More particularly, the format type of an original is determined by original image data used to print an image on an original. Originals having the same image content are classified into the same format type. Therefore, when a plurality of originals is printed by using the same original image data, all of plural sheets of printed originals are of the same format type. Further, all images of the originals printed by using the same original image data include common (same) original attribute information. For example, title characters printed on a title part of an original can be utilized as the original attribute information. To give actual examples, in a case where the original is a question sheet used as a learning material, the title characters representing an applicable school year and a unit of learning content and the like to be printed on the title part of this question sheet may be utilized as the original attribute information. In a case where the original is a questionnaire sheet, title characters to be printed on a title part of this questionnaire sheet may be utilized as the original attribute information.

The original attribute information extraction portion 13 includes a layout analysis portion 131, a title position identifying portion 132, a title image extraction portion 133, and an OCR (Optical Character Reader) processing portion 134.

The layout analysis portion 131 is adapted to perform layout analysis by using image data of an original read by the image reading portion 11. The layout analysis portion 131 is also adapted to recognize regions (image data) of an image of an original by sorting the regions into a title region, a body text region, and the like according to preset recognition conditions (regions, characters, and the like). The title position identifying portion 132 is adapted to specify the position of the title region recognized by the layout portion 131 among the image regions of the original read by the image reading portion 11. The title position identifying portion 132 identifies the title position by setting a two-dimensional coordinate system so that an origin is located at, for example, the position of a leftward upper corner of an image reading area to be read by the image reading portion 1, and by identifying (or calculating) the position of a place, which is recognized by the layout analysis portion 131 as the title region, on this coordinate system using coordinate data (x, y).

The title image extraction portion 133 is adapted to extract an image (a title image) from the place (the title region), whose position is recognized by the title position identifying portion 132 as the title position. The OCR processing portion 134 converts the title image which is extracted by the title image extraction portion 133 to text data by performing OCR processing. Incidentally, in the present invention, it is assumed that the text data representing the title characters is extracted as the original attribute information. However, any other information may be extracted as the original attribute information, as long as such information on, for example, the pattern of an image representing the title characters or an amount of characteristic of such an image, uniquely represents the format of the original.

The information storage portion 14 is adapted to store the original attribute information extracted by the original attribute information extraction portion 13. The information storage portion 14 may be constituted by using a volatile memory (a DRAM or the like), which is similar to or in common with the image memory 12. The information retrieving portion 15 is adapted to perform an information retrieving operation to thereby check whether the original attribute information extracted by the original attribute information extraction portion. The image registration portion 16 is adapted to register (or store) the original attribute information, which is extracted by the original attribute information extraction portion 13, in the information storage portion 14.

A data reduction portion 17 is adapted to perform an operation of reducing (or decreasing) a data amount of the image data of an original, which is read by the image reading portion 11 and is stored in the image memory 12. For example, data compression, such as JPEG compression, or a data thinning process may be applied to the image data as the image data reduction. The data thinning process is a process of thinning dots of image data at a predetermined rate. Therefore, the number of dots per unit area, that is, the dot density of the image data having undergone the data thinning process is lower than that of initial image data. The data transfer portion 18 is adapted to transfer the image data of an original, which is read by the image reading portion 11 and is stored in the image memory 12, or which has undergone the data reduction in the data reduction portion 17, to the PC 2 through the network 3.

A UI (User Interface) portion 19 serves as a user interface used for a user who uses the digital multifunction machine 1 to input various kinds of information thereto and to display various kinds of information to the user. The UI portion 19 is constituted by using an input operation portion, which has various kinds of buttons, switches, keys, and the like, and a display portion, such as a liquid crystal display unit.

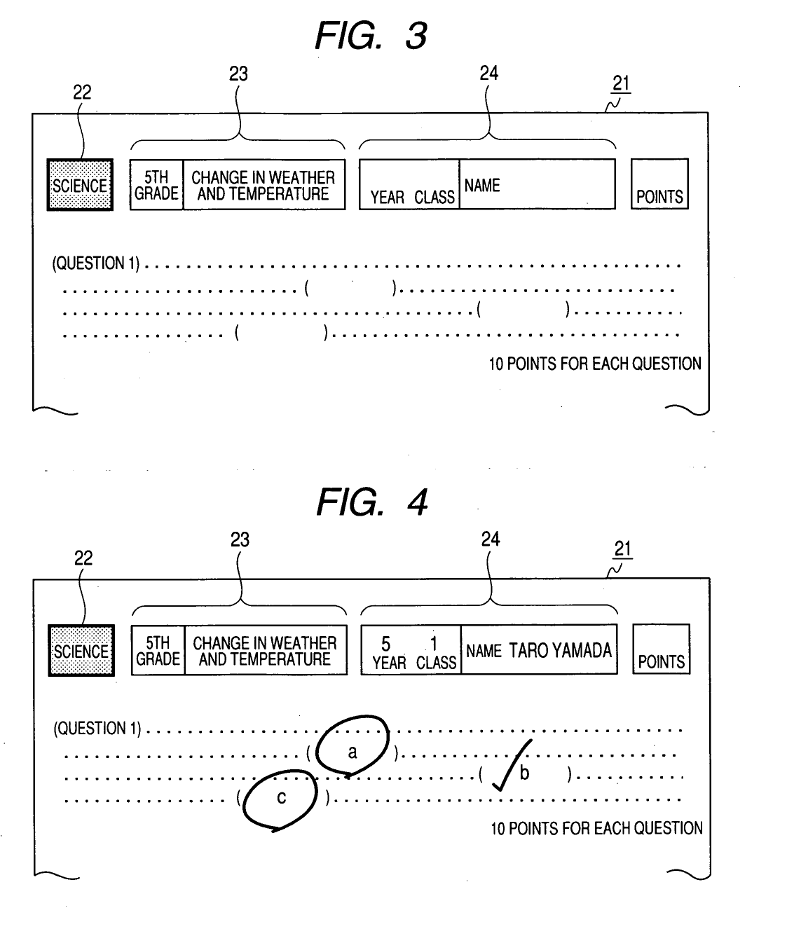

FIG. 3 is a view illustrating the form of a question sheet (an original) to be processed in the embodiment of the invention. An image 22 including characters “SCIENCE” representing a subject is printed in the vicinity of the leftward upper corner of a question sheet 21 shown in this figure. Watermark code information is embedded in this image portion by using electronic watermark techniques. The watermark code information is embedded therein in a state in which the characters “SCIENCE” are visually legible (or readable). Also, title characters 23, such as “5th GRADE” and “CHANGE IN WEATHER AND TEMPERATURE” are printed on the title portion of the question sheet 21. An answerer information column 24, in which the school year, the class, and the name of an answerer are entered (with a pencil), is provided at the right side of the title characters 23.

The aforementioned watermark code information represents an original discrimination information (an original ID) used to uniquely identify the question sheet 21 at, for instance, the PC 2 when the image data of the question sheet 21is transferred from the digital multifunction machine 1 to the PC 2 through the network 3. The PC 2 utilizes various kinds of information needed for marking the question sheet 21, for instance, information on the allocation of marks to each question (or each answer column), answer information representing correct answers to questions on a computer-scored answer sheet, and the aforementioned original discrimination information to read, when the difference between the question sheet 21 and the original image data needs calculating, address information, which designates a storage region that stores the original image data, from a database portion (a hard disk or the like) therein. It is necessary for utilizing the original discrimination information at the PC 2 to extract watermark code information from the image data transferred from the digital multifunction machine 1 and to decode this watermark code information.

For example, a technique “iTone” (registered trademark) of embedding digital information in a halftone image by changing the configuration (the position, the shape, and the like) of pixels constituting a line screen or a dot screen used for gradation representation, or the technique of using “GLYPHCODE” (registered trademark) representing digital information “0” and “1” with a slash and a backslash, respectively, may be employed as the practical techniques of embedding watermark code information.

The question sheet 21 of such a format is put into a state shown in FIG. 4 when the question sheets 21 on which answers are entered are collected and are also marked after a test is performed by actually and respectively distributing the question sheets 21 to students. That is, answerer information is entered by each student (or answerer) in the answerer information column 24 of the question sheet 20. Also, answers are written by a student into (parenthesized) answer columns respectively provided corresponding to questions. Then, a teacher (or judge) marks correct or error marks (O- and x-marks), which indicate that the answer in each of the answer columns is correct or incorrect.

Incidentally, in the case of the question sheet 21 on which the correct and incorrect answer marks are not entered even when image data read from this question sheet 21 is processed by the OCR processing and natural language processing, it is very difficult to exactly grasp the answers handwritten in the answer columns. Thus, in the present embodiment, it is assumed that the question sheet 21 marked with the correct and incorrect answer marks is used as an original, and that the PC 2 determines whether the answer is correct according to the difference in shape between the correct and incorrect answer marks.

Additionally, in a case where the original is a computer-scored answer sheet, even when no correct and incorrect answer marks are put thereon, it can be determined by reading the marks entered as the answer through a mark reading apparatus whether the answer is correct. Also, even in the case of entering the answer by using only numerals, it can exactly be determined by performing the OCR processing on the characters entered as the answer whether the answer is correct. In such cases, when the question sheet and the answer sheet are not marked with circles, the PC 2 which uses the image data can determine whether the answer is correct (or right). A marking operation (or automatic marking) can be achieved according to a result of this determination.

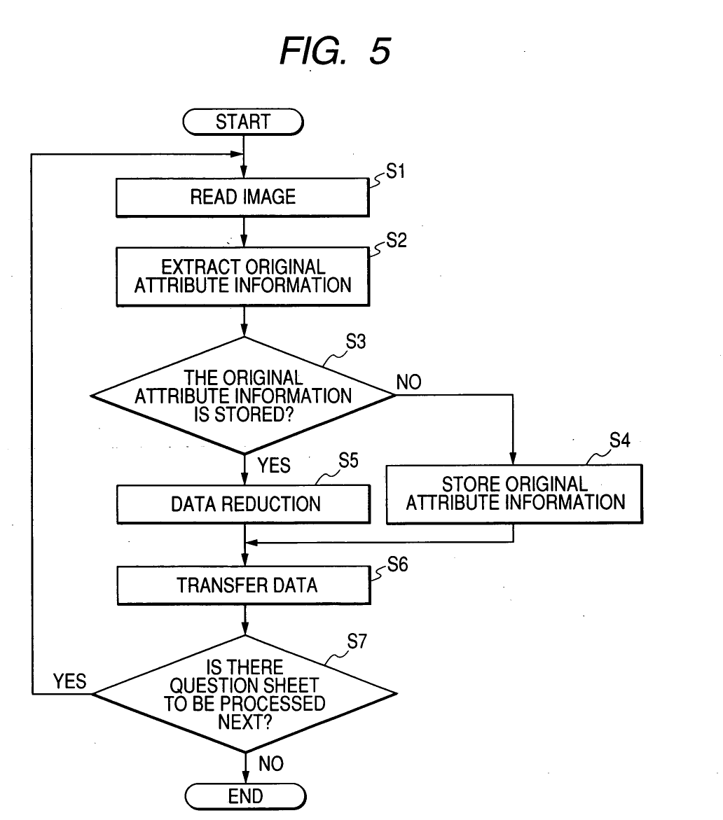

Subsequently, the practical procedure for performing the image processing method using the digital multifunction machine 1 according to the embodiment of the invention is described below by referring to a flowchart shown in FIG. 5.

First, the question sheet 21 marked with the correct and incorrect answer marks is set on an original table of the image reading portion 11. Then, start of an operation is instructed by operating a button or the like of the UI portion 19. Thus, the image of the question sheet 21 is read by the image reading portion 11 in step S1. At that time, the resolution (the reading resolution) of the image reading portion 11 is set to be equal to or higher than the resolution (for instance, 200 spi) required to decode the watermark code information embedded in the image portion 22 of the question sheet 21. Further, image data of the question sheet 21 which is generated at the image reading portion 11 is stored in the image memory 12.

Subsequently, the original attribute information extraction portion 13 uses the image data of the question sheet 21 stored in the image memory 12 and extracts original attribute information from the image data in step S2. In this case, text data representing “5TH GRADE” and “CHANGE IN THE WHETHER AND TEMPERTURE” are extracted from the title portion of the image data of the question sheet 21 as the original attribute information by the layout analysis portion 131, the title position identifying portion 132, the title image extraction portion 13, and the OCR processing portion 134. In this case, for example, even when the character image “W” of the word “WHETHER” is erroneously converted by the OCR processing into a character code representing “M”, all the character images “W” read from the question sheets 21 of the same format are similarly converted into the character code “M”. Thus, OCR precision does not come to an issue in judging whether the questions sheets 21 are of the same format type.

Subsequently, the information retrieving portion 15 checks in step S3 whether the original attribute information previously extracted by the original attribute information extraction portion 13 is stored in the information storage portion 14. At that time, the information retrieving portion 15 uses the original attribute information extracted by the original attribute information extraction portion 13 from the image data read this time as a keyword, and performs a retrieving operation to thereby check whether the original attribute information matched with this keyword is stored in the information storage portion 14.

Further, in a case where the retrieving operation performed by the information retrieving portion 15 reveals that the original attribute information matched with the keyword is not stored in the information storage portion 14, the information registration portion 16 causes the information storage portion 14 to store the original attribute information extracted this time in step S4. Then, the image data read this time is transferred by the data transfer portion 18 to the PC 2 in step S6.

On the other hand, in a case where the retrieving operation performed by the information retrieving portion 15 reveals that the original attribute information matched with the keyword is stored in the information storage portion 14, the data reduction portion 17 performs data reduction on the image data read this time in step S5. The reduced image data is transferred by the data transfer portion 18 to the PC 2 in step S6.

Subsequently, it is checked in step S7 whether the question sheet 21 to be processed next is still present. If present, the procedure returns to step S1. If not, a sequence of steps is finished at that moment. Incidentally, the original attribute information stored in the information storage portion 14 this time is deleted at a moment at which the process at this time is finished.

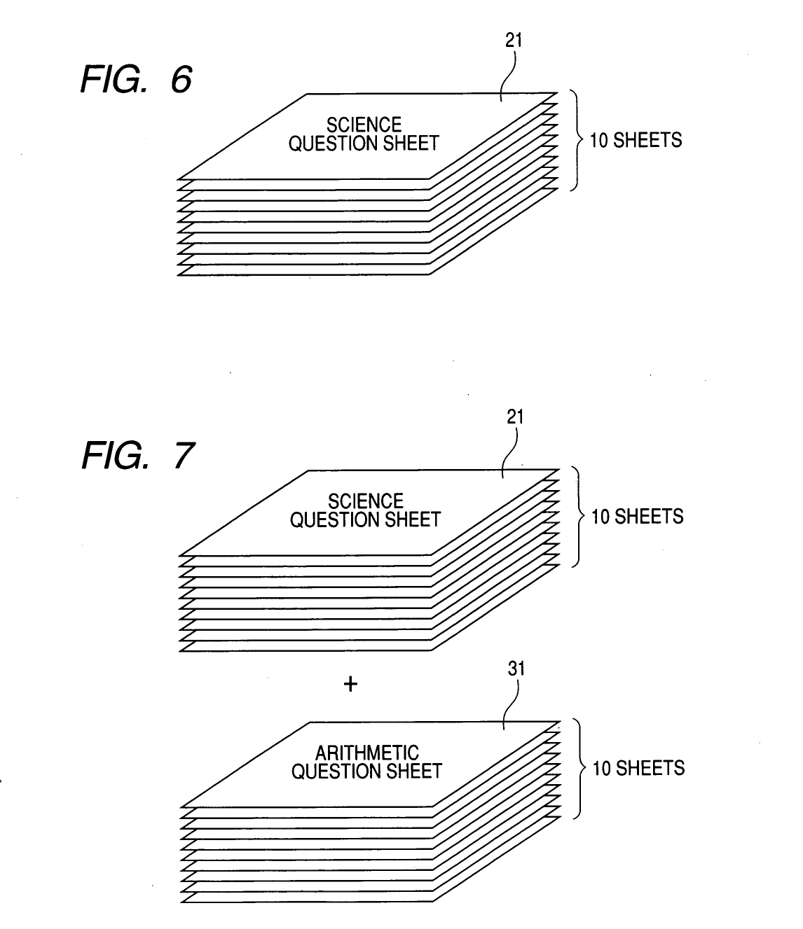

Consequently, in a case where the sequence of steps is performed by stacking the question sheets 21 of the same format as a set of 10 sheets and by setting the question sheets 21 on the original table on the image reading portion 11, as illustrated in, for example, FIG. 6, the procedure at the second question sheet 21 or later is changed from the procedure at the first question sheet 21. That is, in the case of processing the first question sheet 21 from the bottom of the set of sheets, when the original attribute information is extracted from the image data read by the image reading portion 11, the same information as the original attribute information extracted from the image data read this time is not stored in the information storage portion 14. Thus, this original attribute information is stored in the information storage portion 14. Then, this image data is transferred by the data transfer portion 18 without change. Therefore, in a case where it is assumed that the image of the question sheet 21 is read by the image reading portion 11 at a resolution of 200 spi, the image data read at this resolution of 200 spi is transferred by the data transfer portion 18 without change.

In contrast with this, in the case of processing the second to tenth question sheets 21, when the original attribute information is extracted from the image data read by the image reading portion 11, the same information as the original attribute information extracted from the image data, which is read this time, is stored in the information storage portion 14 earlier than this time, that is, at a moment at which the first question sheet is processed. Thus, after the reduction of the image data read this time is performed by the data reduction portion 17, the reduced image data is transferred by the data transfer portion 18. Therefore, for example, in a case where it is assumed that the image of the question sheet 21 is read by the image reading portion 11 at a resolution of 200 spi, the data amount of the image data read at the resolution of 200 spi is reduced by the data reduction portion 17. Thereafter, the reduced image data is transferred by the data transfer portion 18. Thus, as compared with a case where the image data of all the question sheets 21 is transferred without undergoing the reduction, the data of the second or later question sheet 21 can quickly be transferred. The operations of identifying the original and marking in the PC 2 can be performed at a high speed.

Further, in a case where the question sheets 21 for science and the question sheets 31 for arithmetic are stacked as sets of ten sheets and are set on the original table of the image reading portion 11 so that the question sheet 21 differs in format from the question sheet 31 as illustrated in FIG. 7, for instance, and where the sequence of steps is then performed, similarly, the procedure at the first sheet in each of the set of the question sheets 21 and the set of the question sheets 31 is changed from that at the second or later in each of the sets of the question sheets. That is, in the case of processing the first question sheet 31 from the bottom of the set of sheets, when the original attribute information is extracted from the image data read by the image reading portion 11, the same information as the original attribute information extracted from the image data read this time is not stored in the information storage portion 14. Thus, this original attribute information is stored in the information storage portion 14. Then, this image data is transferred by the data transfer portion 18 without change. Further, in the case of processing the second to tenth question sheets 31, when the original attribute information is extracted from the image data read by the image reading portion 11, the same information as the original attribute information extracted from the image data which is read this time is stored in the information storage portion 14 earlier than this time, that is, at a moment at which the first question sheet is processed. Thus, after the reduction of the image data read this time is performed by the data reduction portion 17, the reduced image data is transferred by the data transfer portion 18.

Furthermore, in a case where the eleventh question sheet 21 is processed, when the original attribute information is extracted from the image data read by the image reading portion 11, the same information as the original attribute information extracted from the image data read this time is not stored in the information storage portion 14. Thus, this original attribute information is stored (overwritten) in the information storage portion 14. Then, this image data is transferred by the data transfer portion 18 without change. Further, in the case of processing the twelfth to twentieth question sheets 21, when the original attribute information is extracted from the image data read by the image reading portion 11, the same information as the original attribute information extracted from the image data, which is read this time, is stored in the information storage portion 14 earlier than this time, that is, at a moment at which the eleventh question sheet is processed. Thus, after the reduction of the image data read this time is performed by the data reduction portion 17, the reduced image data is transferred by the data transfer portion 18. Consequently, as compared with a case where the image data of all the question sheets 21 and 31 is transferred without undergoing the reduction, the data of the second or later question sheet of each of the sets of the question sheets 21 and 31 can quickly be transferred. The operations of identifying the original and marking in the PC 2 can be performed at a high speed. Additionally, similar advantages can be obtained even in a case where questionnaire sheets or originals of the same format other than the formats of the question sheet and the questionnaire sheet are treated, instead of the question sheets.

Incidentally, the PC 2 which receives the image data from the digital multifunction machine 1 judges according to the preset conditions whether it is necessary to decode the original discrimination information extracted from each piece of the image data. For example, in a case where the data compression is applied to the reduction of the image data, which is performed by the digital multifunction, the necessity of decoding is judged according to whether the transferred image data is compressed data. That is, in a case where the transferred image data is not compressed data, it is determined that the decoding of the original discrimination information is necessary. In a case where the transferred image data is compressed-data, it is determined that the decoding of the original discrimination information is unnecessary.

Further, in a case where the data thinning process is applied to the reduction of the image data, which is performed in the digital multifunction machine 1, the necessity of decoding is determined according to the (dot) density of the transferred image data. That is, in a case where the density of the transferred image data is higher than a preset reference value, it is determined that the decoding of the original discrimination information is necessary. In a case where the density of the transferred image data is equal to or lower than a preset reference value, it is determined that the decoding of the original discrimination information is unnecessary. Furthermore, in the case where it is determined that the decoding is necessary, watermark code information is actually extracted from the image data. Then, this watermark code information is decoded. Consequently, the original discrimination information is obtained. Also, the original is identified by using this original discrimination information. Conversely, in the case where it is determined that the decoding is unnecessary, the original is identified by using the original discrimination information decoded earlier than this time.

Additionally, as an example of application of the invention, the information storage portion 14 may be enabled to store a plurality of difference pieces of original attribute information during one job (between the start and the end of the process described in the flowchart of FIG. 5) and may be adapted so that every time new original attribute information (original attribute information that is not stored in the information storage portion 14) is extracted in the original attribute information extraction portion 13, the information registration portion 16 assigns a registration number to this original attribute information and then causes the information storage portion 14 to store (or additionally register) this original attribute information. In this instance, in a case where the same information as the original attribute information extracted from the image data read this time has already been stored in the information storage portion 14, the image data is transferred by the data transfer portion 18 by causing the registration number assigned to the original attribute information by the information storage portion 14 to be included in, for instance, header information of the image data to be transferred.

Thus, assuming that every time new original attribute information is extracted, for instance, a registration number set to serially increase from 1 is assigned to this original attribute information and is stored (or additionally registered) in the information storage portion 14, in a case where originals of different two formats (in the illustrated example, the question sheets 21 for science and those 31 for arithmetic) are set on the original table of the image reading portion 11 as one set of sheets, as illustrated in, for example, FIG. 7, the two different kinds of pieces of original attribute information are stored in the information storage portion 14 during a time period between the start and the end of the sequence of steps. The registration numbers are reset upon completion of processing all the originals after the processing is started by setting a predetermined number of originals on the original table. In such a case, a registration number of 1 is assigned to the original attribute information extracted from the image data of the first original. Then, this original attribute information is stored (or registered) in the information storage portion 14. Also, the registration number of 1 is included in header information of the image data. Subsequently, such image data is transferred by the data transfer portion 18. Further, in a case where a second original has the same format as that of the first original, the data reduction of image data read from the second original is performed by the data reduction portion 17. A registration number of 1 is made to be included in header information of the generated image data. Such image data is then transferred by the data transfer portion 18. After that, originals of the same format are processed according to the same procedure as that for processing the second original.

Further, in a case where original attribute information extracted from image data of Mth original differs from the original attribute information to which the registration number of 1 is assigned a registration number of 2 is assigned to the original attribute information extracted from the image data of the Mth original. Then, this original attribute information is stored (or additionally registered) in the information storage portion 14. Furthermore, the registration number of 2 is made to be included in header information of the image data. Then, the image data is transferred by the data transfer portion 18. Additionally, in a case where (M+1)-th original has the same format as that of the Mth original, the data reduction of image data read from the (M+1)-th original is performed by the data reduction portion 17. A registration number of 2 is made to be included in header information of the generated image data. Such image data is then transferred by the data transfer portion 18. Consequently, the PC 2 receiving the transferred image data can easily identify the original discrimination information corresponding to the image data, which has undergone the reduction performed by the digital multifunction machine 1, by referring to the registration number included in the header information of the image data. Therefore, even in a case where a plurality of format types of original are stacked in a random order when a plurality of originals is set on the original table of the image reading portion 11, the originals can be processed without problems.

The image processing apparatus according to the invention is adapted so that when images of a plurality of originals are sequentially read by the image reading means, in a case where information, which is the same as the original attribute information extracted from the image data is already stored in the storage means, the data reduction of the image data of the original read this time is performed, and that subsequently, the reduced image data is transferred by the data transfer means. Thus, for example, in a case where originals having the same format (the same print content), such as a question or questionnaire sheet on which answers have been entered are processed in units of a plurality of sheets thereof, image data read from a second original or later is transferred so that the data amount of the image data is less than the data amount of the image data read from a first original.

According to the invention, in a case where originals of the same format are processed in units of a plurality of sheets thereof, it is controlled whether the reduction of image data is performed by the data reduction means with reference to the original attribute information representing the format type of the original. Thus, image data read from a second original or later can be transferred so that the data amount of the image data is less than the data amount of the image data read from a first original. Therefore, in a case where image data of originals of the same format which includes watermark code information is exchanged on a network many times, image data read from a first original at a resolution required to decode watermark code information is transferred without change. Image data read from a second original or later is transferred by reducing a data amount. Consequently, the transfer of image data can efficiently be performed.

The entire disclosure of Japanese Patent Application No. 2005-181383 filed on Jun. 22, 2004 including specification, claims, drawings and abstract is incorporated herein be reference in its entirety.

What is claimed is:

1. An image processing apparatus comprising:
an image reading portion that reads an image of an original to obtain image data;
an extraction portion that extracts original attribute information for representing format type of the original from the image data;
an information storage portion that stores the original attribute information;
a data reduction portion that reduce a data amount of the image data; and
a data transfer portion that transfer the image data through a network;
wherein the image reading portion obtains the image data while determining if the original attribute information is stored in the information storage portion; and
wherein when it is determined that the original attribute information is stored in the information storage portion, the data reduction portion reduces the image data to be transferred by the data transfer portion.

2. The image processing apparatus according to claim 1,
wherein the image reading portion reads the image of the original at a resolution that enables watermark code information embedded in the image data to be decoded.

3. The image processing apparatus according to claim 1,
wherein the original attribute information includes a plurality of pieces of the original attribute information.

4. A network system comprising:
a image processing apparatus that transfer image data obtained by reading an image of an original; and
an information processing apparatus that perform a predetermined process by using the image data transferred from the image processing apparatus through the network;
wherein the image processing apparatus includes:
an image reading portion that reads an image of an original to obtain image data;
an extraction portion that extracts original attribute information for representing format type of the original from the image data;
an information storage portion that stores the original attribute information;
a data reduction portion that reduce a data amount of the image data; and
a data transfer portion that transfer the image data through a network;
wherein the image reading portion obtains the image data while determining if the original attribute information is stored in the information storage portion; and
wherein when it is determined that the original attribute information is stored in the information storage portion, the data reduction portion reduces the image data to be transferred by the data transfer portion.
